(19) United States
(12) Patent Application Publication
(10) Pub. No.: US 2023/0103324 A1
(43) Pub. Date: Apr. 6, 2023

(54) OFFSHORE SPAR PLATFORM

(71) Applicant: EQUINOR ENERGY AS, Stavanager (NO)

(72) Inventors: Terje NYBØ, Colorado Springs, CO (US); Oddgeir DALANE, Colorado Springs, CO (US)

(21) Appl. No.: 17/906,137

(22) PCT Filed: Mar. 26, 2021
(86) PCT No.: PCT/NO2021/050087

§ 371 Date: Sep. 12, 2022

(30) Foreign Application Priority Data
Mar. 26, 2020 (GB) 2004392.3

(51) Int. Cl. B63B 35/44; B63B 39/02; B63B 5/14; E21B 33/035; A62C 3/00

(52) U.S. Cl. CPC B63B 35/44; B63B 39/02; B63B 5/14; E21B 33/035; A62C 3/00; B63B 2035/448; B63B 2035/442

(57) ABSTRACT

A floating, unmanned wellhead or production facility includes a topside configured to process a hydrocarbon fluid, and a spar hull supporting the topside. The spar hull is designed to minimize maintenance and thus does not include many of the systems commonly found in the hull of a floating offshore facility. Systems that are not present within the spar hull include an active ballast system, a bilge system, a drainage system, an active zone isolation system, a fire detection and suppression system, and an internal lighting system.

The present disclosure relates to the design of a spar platform for a floating offshore hydrocarbon processing facility.

Offshore hydrocarbon processing facilities commonly take the form of a spar platform, comprising a floating spar hull supporting a topside or deck. The spar platform is typically permanently anchored to the sea bed, such as by catenary moorings, and comprises a single, large-diameter cylindrical or prismatic hull that is filled with air and has ballast located at the bottom. The topside houses any necessary drilling and production equipment.

Typically, the spar hull is a complex structure housing multiple systems, as well as access ways for performing maintenance of those systems. Exemplary systems commonly found in the spar include: an active ballast system that pumps water between tanks within the spar to maintain an even keel, a drainage system to collect water from various locations around the spar hull, a bilge system to pump accumulated water out of the spar hull, a fire control system for detection and suppression of fires within the hull, a zone isolation system comprising watertight doors, barriers and the like for sealing passageways between zones of the hull in the event of a hull breach, an electric lighting system, etc.

The present invention provides a floating offshore facility comprising: a topside configured to receive a hydrocarbon fluid, process the hydrocarbon fluid to produce one or more processed hydrocarbon fluid, and output the one or more processed hydrocarbon fluid; and a spar hull supporting the topside, wherein the spar hull does not comprise at least one of: an active ballast system, a bilge system, and a drainage system.

Whilst many of the systems commonly provided within the hull of a floating offshore facility are beneficial for the operation of the facility, such systems significantly increase the complexity of the facility and add many maintenance hours over the course of the year. Recently there has been a move towards unmanned facilities, and in such systems it is desirable to minimise the number of maintenance hours required on the platform. Often, for unmanned facilities, there is a cap on the total number of maintenance hours per year for the entire platform, and it has been difficult to meet this for some projects. In the past, the systems described above have been treated as essential within the hull, and in fact these systems have been specified as mandatory in some national and international regulations and standards. However, it has been recognised by the inventors that when permanent crew are not stationed on the topside, many of these complex systems can in actuality be removed within a spar type hull without adversely impacting the functionality or safety of the facility. This is because of the inherent stability of a spar hull in both intact and damaged condition.

The removal of these systems in some instances has been sufficient to reduce the number of maintenance hours to below the cap, thereby enabling for the project to become viable. Advantageously, the omittance of these systems also reduces the capital expenditure during the project phase, and the operational expenditure during the operational phase.

In some embodiments, the spar hull does not include an active ballast system. An active ballast system is a system configured to move mass within the spar hull so as to maintain an even keel, i.e. such that the topside remains level, preferably both in normal operation and in a damaged condition. Thus, an active ballast system is typically configured to monitor an orientation of the spar hull and/or the topside, and to move mass within the spar hull responsive to the orientation. Typically an active ballast system comprises one or more pumps configured to move water or other fluids between tanks within the spar hull or to dump water to the sea in case of an accident.

An active ballast system is commonly used in combination with fixed ballast, such as iron ore at the bottom of the spar hull. The floating offshore facility may still comprise fixed ballast, even when it does not comprise active ballast system. In some embodiments, the spar hull may comprise ballast that can be adjusted after deployment of the facility, but is not actively controlled during operation of the facility. For example, when deploying the spar, water or other ballast may be moved within the spar hull (e.g. by pumping water into tanks within the spar hull using an external pump system) to achieve an even keel, but during normal operation of the facility the ballast is not moved and the spar hull does not comprise pumps for doing so.

The omission of an active ballast system does not cause problems in a unmanned facility because there are no permanent crew on the facility to perceive the variations, and typically the processing equipment do not require strict maintenance of an even keel. Furthermore, in an unmanned facility, there are typically very few changes in the distribution of mass within the topside, meaning that the centre of mass of the facility does not change frequently or significantly. Thus, in some embodiments, the ballast can be configured only once at the time of deployment and does not need to be subsequently changed.

In some embodiments, the spar hull does not include a bilge system. A bilge system is a system comprising at least one pump to remove accumulated water from within the spar hull. Typically, a bilge system will include one or more bilge (or compartment) that accumulates water, where the pump is configured to remove accumulated water from the bilge. A bilge system may be configured to remove water accumulated from condensation, leakage, washing, firefighting and various other sources. Typically, a bilge system would be capable of controlling flooding as a result of damage to internal piping systems, but not flooding resulting from major hull damage.

In some embodiments, the spar hull does not include a drainage system. A drainage system is a network of piping configured to collect water from a plurality of locations within the spar hull. For example, the water may be collected in a bilge or similar compartment.

Optionally, the spar hull may not comprise at least two of: an active ballast system, a bilge system, and a drainage system. In some embodiments, the spar hull may not comprise any of an active ballast system, a bilge system, and a drainage system.

In some embodiments, the spar hull may not comprise an active zone isolation system. An active zone isolation system is a system configured to controllably isolate one or more zones within the spar hull, for example by closing water-tight doors, hatches or other barriers. Commonly, the active zone isolation system may be automatically or remotely controllable. Typically, an active zone isolation system is triggered in response to flooding within the spar hull, so as to prevent water filling multiple zones within the spar hull, which could adversely affect stability of the facility. Thus, in some embodiments, the spar hull may not comprise controllable or openable waterproof doors and/or hatches. Whilst the spar hull may not comprise an active zone isolation system, the spar hull may nevertheless be divided into compartments, for example in order to stay afloat if there is a fatigue crack through the hull plating, or damage caused by ship collision etc.

In some embodiments, the spar hull may not comprise one or both of a fire suppression system and a fire detection system. A fire detection system is any system configured for detection of fire. Such a system would typically include a plurality of heat and/or smoke detectors. It may also include manual call points. It may also include an alarm system. A fire suppression system may comprise systems for suppressing and/or impeding spread of a fire. Such systems may include dry or wet chemical suppression system, water suppression systems, such as sprinklers, and gaseous suppression systems, as well as fire resistant barriers, such as fire doors.

In some embodiments, the spar hull may not comprise an internal lighting system. That is to say, the spar hull may not comprise lighting or the associated wiring to illuminate passageways or the like within the spar hull structure itself. The spar hull may however still include an external lighting system for illuminating the outside surfaces of the spar hull. Of course, it will be appreciated that the topside will most likely still include a lighting system.

In some embodiments, the spar hull may not be designed to permit internal access to the spar hull whilst deployed. For example, the spar hull may not comprise passageways and the like that can be accessed after deployment.

In some embodiments, the spar hull may not comprise a power supply network. For example, the spar hull may comprise no internal wiring carrying electrical power for supply to machinery or the like. Thus, the spar hull may in some embodiments comprise no electrically-powered machinery.

An outer hull of the spar may be formed from concrete, metal or a combination thereof. The spar hull may define one or more chamber, which may provide buoyancy for the facility. The chamber may be an air-filled chamber. The spar hull may define one or more structural ribs to maintain the integrity of the outer hull surrounding the chamber.

The spar hull may define one or more cofferdam, which may be located at the waterline following deployment. For example, the one or more cofferdam may be located to receive water entering the spar hull in the event that the spar hull is breached by a ship impact. The or each cofferdam may comprise a chamber that is adjacent the outer hull of the spar hull and is fluidly isolated from the air-filled chamber discussed above.

In one embodiment, for example when an outer hull of the spar is formed from concrete, the spar may comprise a primary, air-filled primary chamber that accounts for most of the internal volume of the spar hull, for example at least 50% and more preferably at least 80%. The primary chamber is preferably substantially sealed, i.e. such that the interior cannot be accessed after deployment. The spar hull may further comprises the one or more cofferdam described above.

In another embodiment, for example when an outer hull of the spar is formed from metal, the spar hull may comprise a plurality of air-filled chambers providing buoyancy, which may each also act as a cofferdam.

In one embodiment, the floating offshore facility may be a wellhead platform. The hydrocarbon fluid received by the topside may comprise a hydrocarbon well stream, such as from one or more hydrocarbon wells. The hydrocarbon well stream may be a multiphase fluid comprising a mixture of liquid hydrocarbons, gaseous hydrocarbons and water. The processing may comprise separating a multiphase hydrocarbon fluid into a gas-phase hydrocarbon fluid and liquid-phase hydrocarbon fluid. Optionally, water may be removed from the fluid.

Thus, the one or more processed hydrocarbon fluid may comprise a gas-phase hydrocarbon fluid and a liquid-phase hydrocarbon fluid. Optionally, the facility may output water as well, for example for reinjection into a reservoir. The gas-phase hydrocarbon fluid and/or a liquid-phase hydrocarbon fluid may be processed to meet pipeline transportation specifications. A pipeline transportation specification defines maximum permissible levels of certain compounds within the fluid, such as water, sour gases, etc.

In another embodiment the floating offshore facility may be a production platform. For example, the facility may be capable of processing a received hydrocarbon fluid to meet sales specification. A sales specification is usually a higher standard than a pipeline transportation specification. The hydrocarbon well stream may be a multiphase fluid comprising a mixture of liquid hydrocarbons, gaseous hydrocarbons and water, or may be a substantially single-phase fluid. The hydrocarbon well stream may be a well stream, or may be a partially-processed hydrocarbon stream. The one or more processed hydrocarbon fluids are preferably each a substantially single-phase fluid.

The facility is preferably an unmanned platform. That is to say, it is a platform that has no permanent personnel and may only be occupied for particular operations such as maintenance and/or installation of equipment. The unmanned platform may be a platform where no personnel are required to be present for the platform to carry out its normal function, for example day-to-day functions relating to handling of oil and/or gas products at the platform. In developing an unmanned platform it is a particular benefit for the maintenance hours to be kept to a minimum, since then the need for personnel on the platform is minimised. Therefore there is a synergy between the feature of an unmanned platform and the reduction in the need for functionality incorporated within the spar hull.

The facility may have a displacement of greater than 25,000 tonnes.

The facility may be configured to use a “Walk to Work (W2W)” system for example using a gangway from a service vessel or to another platform. The length of the bridge may be about 50 m or above, optionally about 75 m or above.

An unmanned platform may be a platform with no provision of facilities for personnel to stay on the platform, for example there may be no shelters for personnel, no toilet facilities, no drinking water and/or no personnel operated communications equipment. The unmanned platform may also include no heli-deck and/or no lifeboat, and advantageously may be accessed in normal use solely by the gangway or bridge, for example via a Walk to Work (W2W) system as discussed above.

An unmanned platform may alternatively or additionally be defined based on the relative amount of time that personnel are needed to be present on the platform during operation. This relative amount of time may be defined as maintenance hours needed per annum, for example, and an unmanned platform may be a platform requiring fewer than 10,000 maintenance hours per year, optionally fewer than 5000 maintenance hours per year, perhaps fewer than 3000 maintenance hours per year.

An unmanned platform may also alternatively or additionally be defined based on the number of days that at least one member of personnel is present on the platform during operation. This amount of time may be defined as manned days needed per annum, for example, and an unmanned platform may be a platform requiring fewer than 90 manned days per year, optionally fewer than 60 manned days per year, further optionally fewer than 30 manned days per year, and perhaps fewer than 15 manned days per year.

There is of course a clear inter-relationship between reducing the maintenance hours or manned days needed and the reducing the complexity of the spar hull, amongst other things.

Preferred embodiments of the present disclosure will now be described in greater detail, by way of example only and with reference to the accompanying drawings, in which:

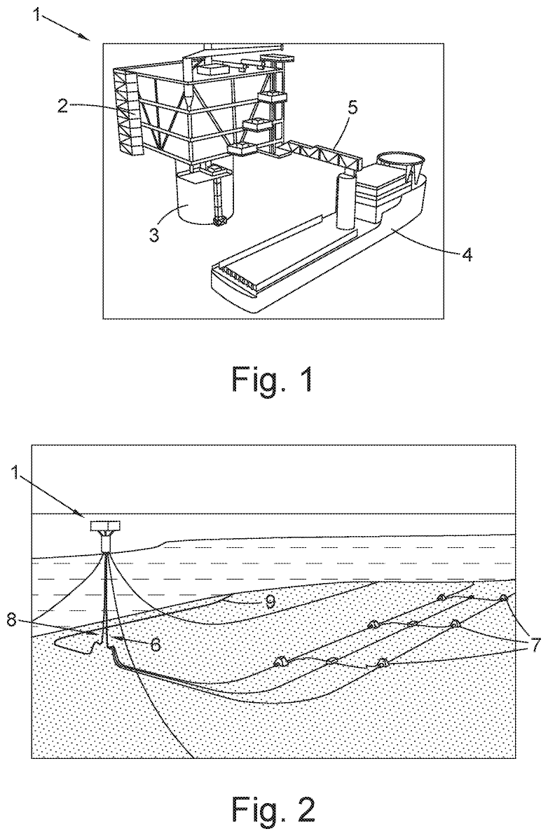

FIG. 1 shows a topside of an unmanned wellhead platform whilst connected to a service vessel via a “Walk to Work” system;

FIG. 2 shows an underwater configuration of the unmanned wellhead platform;

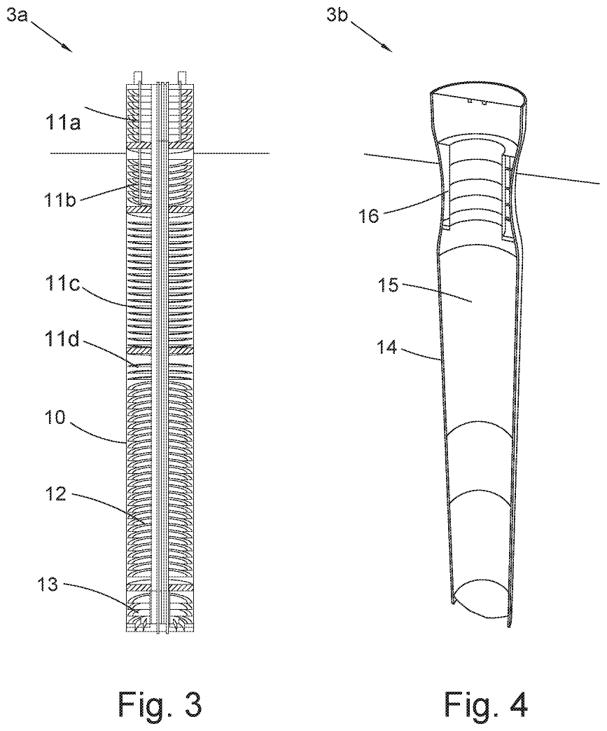

FIG. 3 shows a first embodiment of a spar hull for use with the unmanned wellhead platform; and

FIG. 4 shows a second embodiment of a spar hull for use with the unmanned wellhead platform.

FIG. 1 shows an unmanned wellhead platform 1.

The platform 1 comprises a topside 2 and a spar hull 3. The topside includes all necessary processing equipment to perform the functions required by the platform 1. The spar hull 3 provides the necessary buoyancy to support the topside 2.

The platform 1 is an unmanned platform, and as such has been designed with the intent that it will require no permanent personnel to carry out its normal function, and will only be occupied for particular operations such as maintenance and/or installation of equipment. Thus, the platform 1 has no provision of facilities for personnel to stay on the platform for a prolonged period of time, such as overnight. Such platforms are typically much cheaper to install and maintain than manned platforms, making them particularly useful for extraction of hydrocarbons from marginal wells, which might otherwise not be commercially viable.

The unmanned platform 1 does not include a heli-deck or lifeboats, and is designed to be accessed in normal use solely by a bridge 5, known as a Walk to Work (W2W) system. The gangway 5 connects the topside 2 of the platform 1 to a service vessel 4 in the illustrated embodiment. However, in other implementations, the bridge 5 may connect to another, manned platform. The length of the bridge is typically about 100 m long.

Referring the FIG. 2, the illustrated platform 1 is an unmanned wellhead platform 1. Thus, the platform 1 is connected to a plurality of production risers 6, which receive wellstream fluid from a plurality of manifolds 7 connected to wellheads on the seabed. The wellstream fluid received via the production risers 6 is processed by equipment on the topside 2, which may perform processes such as separation, dehydration, acid gas removal, and the like. The processed hydrocarbons are then output via export risers 8, which carry the processed hydrocarbons back to the seabed for supply to a subsea pipelines 9 for onward transport, for example back to shore or to a further offshore processing facility.

As the platform 1 is designed to be unmanned during normal operation, it is important to minimise the maintenance requirements of the facility. Typically, an unmanned facility such as that illustrated may be designed to have fewer than 3000 maintenance hours per year. This may, for example, facilitate maintenance to be carried out twice per yet in two one-week maintenance visits. Whilst additional or longer maintenance visits can be carried out, each visit significantly increases the costs associated with operation of the platform 1, and thus reduce the viability of marginal hydrocarbon reservoirs.

The inventors have recognised that a large number of systems typically incorporated within the spar hull 3 of the platform 1 do not provide significant advantages within the context of an unmanned facility. However, such systems are often quite complex and must still be regularly maintained. The maintenance of the spar hull systems adds a significant number of annual maintenance hours to the overall annual maintenance hours of the platform 1. It is therefore proposed to significantly simplify the construction of the spar hull 3.

FIG. 3 illustrates a first embodiment of a spar hull 3a for use with the offshore platform 1.

The spar hull 3a is a metal spar hull and comprises a hollow, cylindrical outer hull 10, which in this embodiment is formed from steel. In order to minimise the weight of the hull 10a, annular ribs are formed on the inside of the hull 10a to improve structural stability.

The spar hull 3a comprises a plurality of annular chambers 11 that provide buoyancy for the platform, and define a central passageway 12 through the spar hull 3a for risers 6, 8 or umbilicals to be run to the seabed. This arrangement protects any risers 6, 8 or umbilicals from collisions, as well as from wear due to exposure to the splash zone of the platform 1.

In the illustrated embodiment, the spar hull 3a comprises four annular compartments 11a-11d. These are each filled with air and are fluidly isolated from one another. In some embodiments, each of these annular compartments may be further subdivided into segments, for example into four equal chamber sectors.

The chamber 11b that is at sea level acts as a cofferdam. Thus, in the event that the hull 10 is breached by a ship impact, this chamber 11b (or one sector thereof) will fill with water. However, the other chambers 11a, 11c, 11d are fluidly isolated and thus continue to provide buoyancy to the platform 1.

The hull 10 extends beyond these annular chambers 11a-d and defines a water-filled chamber 12 which provides damping against sea movements. At the bottom of the hull 10 is a ballast chamber 13. As above, this chamber 13 maybe subdivided into segments, for example into four equal chamber sectors. The ballast chamber 13 may be filled with a permanent ballast, typically iron ore.

FIG. 4 illustrates a second embodiment of a spar hull 3b for use with the offshore platform 1.

The spar hull 3b is a substantially concrete spar hull and comprises a hollow, approximately cylindrical outer hull 10, which in this embodiment is formed from concrete. In the illustrated embodiment, the spar hull 3b defines a single, primary chamber 15, which accounts for most of the volume within the hull 14. The primary chamber 15 is filled with air and is completely sealed. This chamber 15 provides the buoyancy for the platform 1. Risers 6, 8 or umbilicals that need to run to the seabed are run along the outside of the hull 14.

The spar hull 3b further comprises an annual cofferdam 16 that is positioned at sea level between the hull 14 and the primary chamber 15. Thus, in the event that the hull 14 is breached by a ship impact, this chamber 14 will fill with water. However, the primary chamber 15 remains fluidly isolated and thus will continue to provide buoyancy to the platform 1. In the illustrated embodiment, the cofferdam 16 is isolated from the primary chamber by a steel wall coupled to the concrete hull 14.

Whilst not shown, permanent ballast may also be provided at the bottom of the concrete spar hull 3b.

As will be appreciated, the spar hulls 3a, 3b described above are designed with the intention that they do not contain any machinery requiring maintenance. Thus, the spar hulls 3a, 3b do not comprise any of an active ballast system, a bilge system, and a drainage system, which would normally be expected to be found within the spar hull 3 of an offshore platform 1.

Indeed the spar hulls 3a, 3b are not designed with the intention of permitting internal access to the spar hull whilst deployed. Therefore, systems associated with occupancy of the spar hulls 3a, 3b are also not required. Thus, the spar hulls 3a, 3b also do not comprise a zone isolation system, a fire suppression and/or detection system, an internal lighting system, or access passageways.

We claim:

1. A floating offshore facility comprising:
a topside configured to receive a hydrocarbon fluid, process the hydrocarbon fluid to produce one or more processed hydrocarbon fluid, and output the one or more processed hydrocarbon fluid; and
a spar hull supporting the topside,
wherein the spar hull does not comprise at least one of: an active ballast system, a bilge system, and a drainage system.

2. A floating offshore facility according to claim 1, wherein the spar hull does not comprise any of an active ballast system, a bilge system, and a drainage system.

3. A floating offshore facility according to claim 1, wherein the spar hull does not comprise an active zone isolation system.

4. A floating offshore facility according to claim 1, wherein the spar hull does not comprise one or both of a fire suppression system and a fire detection system.

5. A floating offshore facility according to claim 1, wherein the spar hull does not comprise an internal lighting system.

6. A floating offshore facility according to claim 1, wherein the spar hull is designed not to permit internal access to the spar hull whilst deployed.

7. A floating offshore facility according to claim 1, wherein the spar hull defines one or more cofferdam located at a waterline following deployment.

8. A floating offshore facility according to claim 1, wherein the spar hull is formed from concrete, metal or a combination thereof.

9. A floating offshore facility according to claim 1, wherein the spar hull comprises a concrete hull defining a primary, air-filled chamber comprising at least 80% of the internal volume of the spar hull.

10. A floating offshore facility according to claim 1, wherein the spar hull comprises a metal hull defining a plurality of air-filled chambers.

11. A floating offshore facility according to claim 1, wherein the floating offshore facility is a wellhead platform.

12. A floating offshore facility according to claim 1, wherein the floating offshore facility is a production platform.

13. A floating offshore facility according to claim 1, wherein the floating offshore facility is an unmanned platform.
